(19) United States
(12) Patent Application Publication
(10) Pub. No.: US 2020/0065880 A1
(43) Pub. Date: Feb. 27, 2020

(54) HYBRID RECOMMENDATION MECHANISM FOR REALTIME BASKET ANALYSIS

(71) Applicant: SAP SE, Walldorf (DE)

(72) Inventors: Roni Ramon-Gonen, Herzliya (IL); Oren Haze, Kfar Saba (IL)

(21) Appl. No.: 16/113,770

(22) Filed: Aug. 27, 2018

(51) Int. Cl. G06Q 30/06; G06F 17/30

(52) U.S. Cl. CPC G06Q 30/0631; G06F 17/3053; G06F 17/30867; G06F 17/30554

(57) ABSTRACT

A request for recommending an item is received from a clients server, wherein the request comprises baskets data, and the basket data are associated with multiple baskets and multiple items. At least one recommendation model is built based on an Optimized Recommendations based Basket Size (ORBS) algorithm. The baskets data is processed using the recommendation model to generate a recommendation result, and the recommendation result comprises a recommended item. The recommendation result is sent to the client server to render the recommended item to be displayed on a user interface of a user device.

### BACKGROUND

Basket analysis is an application of data mining algorithms aimed at identifying frequent patterns and co-concurrence relationships in a large transactional database. Basket analysis can be used, for example, in cross-selling of items at retail websites, proper replacement of items in shopping malls or supermarkets, consumer behavior analysis, and fraud detection.

### SUMMARY

The present disclosure describes a hybrid recommendation mechanism for real-time basket analysis.

In an implementation, a request for recommending an item is received from a server (for example, a client's server), wherein the request comprises baskets data, and the basket data are associated with multiple baskets and multiple items. At least one recommendation model is built based on an Optimized Recommendations based Basket Size (ORBS) algorithm. The baskets data is processed using the recommendation model to generate a recommendation result, and the recommendation result comprises a recommended item. The recommendation result is sent to the client server to render the recommended item to be displayed on a user interface of a user device.

Implementations of the described subject matter, including the previously described implementation, can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented so as to realize one or more of the following advantages. First, data security and user privacy are protected by using transactional data as input for a proposed recommendation model used by a hybrid recommendation mechanism to generate recommendation results (for example, for items in an online shopping cart or basket). Second, parameters for the recommendation model can be automatically activated without intervention from experts, therefore improving data processing efficiency. Third, various basket/transaction sizes are considered by the hybrid recommendation mechanism, improving the quality of the recommendation results. Fourth, the recommendation results can be explained to users (for example, how a specific recommendation was calculated).

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a flowchart illustrating an example of a computer-implemented method for generating real-time recommendations based on a hybrid mechanism, according to an implementation of the present disclosure.

FIG. 2A is a graph illustrating a result of a test performed to evaluate the hybrid recommendation mechanism, according to an implementation of the present disclosure.

FIG. 2B is a graph illustrating a result of a test performed to evaluate the hybrid recommendation mechanism, according to an implementation of the present disclosure.

FIG. 3 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes a hybrid recommendation mechanism for real-time basket analysis, and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

Today, more and more retailers are creating an online website to enable customers to create sales orders and to perform purchase through their websites. In some implementations, these types of orders are managed by adding items to shopping baskets and performing transactions. To increase purchases and revenue, retailers can add a product recommendation function to their websites. For example, after a customer adds a product A to a shopping cart or basket (each term can be used interchangeably or together depending on context), the website can recommend another product B (such as by displaying product B on the screen) to the user for purchase. Product recommendations appropriate to customers (for example, product recommendations catering to individual shopper preferences and shopping habits) have a higher chance to be adopted by customers. Therefore, a smart mechanism that can generate a recommendation appropriate for customers at an appropriate time (for example, in real-time) is desired for retailers.

Currently, several recommendation algorithms are used for generating item recommendation results to consumers. Recommendation algorithms can include, for example, Content-based Filtering, an Association Rule (AR) Learning, Collaborative Filtering (CF), and Neural Network-based Collaborative Filtering (NCF). Among these examples, the Content-based Filtering that uses textual input data uses the Term Frequency Inverse Document Frequency (TF-IDF) algorithm. the TF-IDF algorithm is often used in Information Retrieval (IR) and Natural Language Processing (NLP) for identifying important words in a document and by search engines to find documents that are relevant to a particular search query (for example, to recommend a document provided by a search query result).

AR learning is a method for discovering interesting relationships between variables in large databases and is used to analyze retail basket or transaction data (for example, Market Basket Analysis). AR learning is intended to identify strong rules discovered in transaction data using measures of “interestingness” (such as, “Customers who buy diapers also buy beer in the same transaction” or “People that buy NIKE shoes also purchase KIT KAT candy bars.”).

CF is a technique used by recommender systems for making automatic predictions about interests of a user by collecting preferences or taste information from many users. The underlying assumption of the CF approach is that, if a person A has the same opinion as a person B on an issue, A is more likely to have B's opinion on a different issue than that of a randomly chosen person.

ANNs or connectionist systems are computing systems vaguely inspired by the biological neural networks that constitute animal brains. Such systems can be considered to “learn” tasks by considering examples, generally without task-specific programming.

These existing solutions have significant weaknesses with respect to shopping cart/basket analysis. For example, the existing solutions lack support for some privacy regulations (such as, the General Data Protection Regulation (GDPR)) due to lack of anonymity. That is, data associated with a user's identity and privacy are used for basket analysis, increasing a possibility of secure data leakage. Second, the existing solutions lack support for automation and require interventive action(s) by experts, resulting in inefficient data processing. For example, in the existing solutions, each algorithm can have different parameters that need to be specified. As a result, finding appropriate parameters for each desired scenario requires analysis by an expert, and makes it difficult to distribute or to use the solution in an optimal way. Further, recommendations made by the existing solutions are typically of low-quality because the existing solutions lack support for baskets/transactions of differing sizes. Existing algorithms that process data without differentiating between baskets/transactions of different sizes, render inaccurate recommendation results. Additionally, the existing solutions lack transparency. When reviewing recommendation results generated by the existing solutions, users are unable to understand how a particular recommendation was calculated or why the particular recommendation was provided to them by the existing solution. How the recommendation result was calculated is important for a user (for example, a business, organization, or individual) to better understand the recommendation result (for example, their customers and what influences the customers during a sale process). Lack of an ability to explain the reason for receiving a recommendation result can influence overall recommendation system performance.

This specification discloses a new hybrid recommendation mechanism (that is, Optimized Recommendations based Basket Size (ORBS)) that based on one or more active algorithms. The described hybrid recommendation mechanism returns recommendations based on a received request. Different recommendation models can be built according to data in the received request. When the hybrid recommendation mechanism receives only transactional data (that is, data associated with baskets and items inside and outside the baskets), a new ORBS algorithm is used as an active algorithm, and recommendations can be made through determining an ORBS score for each candidate item for recommendation. The new ORBS algorithm is based on a combination of TF-IDF, a method that comes from Natural Language Processing (NLP) and Information Retrieval (IR), ideas from AR methods, and ideas from the business world in which there is a separation between Large Enterprises (LE) and Small and Medium-sized Businesses (SMB). At a high-level, the logic of the ORBS algorithm is, given a collection of shopping baskets/transactions, for each item X or combination of items, the hybrid recommendation mechanism calculates which item Y to recommend to the customer, after the customer has inserted this item X/combination of items into their basket. The recommendation is based on the item Y that received the highest ORBS score. For example, if the customer added diapers to the basket, the hybrid recommendation mechanism determines which product(s) to recommend to the customer by calculating the ORBS score of a combination of “Diapers, Product Y”. The hybrid recommendation mechanism recommends the product for which the combination “Diapers, Product Y” possesses the highest ORBS score or several products with the highest ORBS scores.

In some implementations, the ORBS score is calculated based on:

$$ORBS = IFBS * IRF = \frac{CNTk ( X ⋃ Y )}{K} \times log \frac{N}{CNT ( Y )} , \qquad ( 1 )$$

where:
CNTₖ (X∪Y)=number of times X and Y appear together in the same basket/transaction, out of baskets/transactions with maximum k items,
K=number of baskets/transactions with maximum k items,
N=total number of baskets/transactions,
CNT(Y)=number of times Y appears in the total baskets/transactions,
k is a predefined parameter,
The left component of the formula (IFBS) expresses how frequently the items appear together among baskets up to a certain size, and
The right component in the formula (IRF) expresses the rareness of the potential recommended item in the data set (a collection of all baskets/transactions). The rarer the product, the higher the score.

In cases where the customer provides more data (such as, user_id, payment method, location, time, customer demographic data, or product metadata), a combination of different algorithms (for example, Contextual Top-N, AR, CF, ORBS, or manual rules) can be used as active algorithms for the hybrid recommendation mechanism to return recommendation results. In case there are several active algorithms that return recommendations for the consumer, the hybrid recommendation mechanism can calculate an aggregated score (as explained below) and return a recommendation result with a highest aggregated score.

In addition, the hybrid recommendation mechanism can collect a consumer's feedback for each provided recommendation result(s) (such as, whether the consumer accepted the item recommended by the hybrid recommendation mechanism). The feedback, as well as additional data (such as, business priority), can also be considered when ranking different recommendation results and adjusting parameters for the hybrid recommendation mechanism. By using transactional data as input to the recommendation model of the hybrid recommendation mechanism and differentiating basket/transaction sizes, the hybrid recommendation mechanism can render higher-accuracy recommendation results and can better protect data integrity and user privacy.

The disclosed solution can be used in various manners (for example, e-commerce systems, shopping sites, or call centers) where automatic, learning-based item recommendations are needed by customers. In addition, the described hybrid recommendation mechanism is generic in nature, and the disclosed hybrid recommendation mechanism can also be used in computing systems where item recommendations are needed, and there is transactions information available (such as, television (TV) program recommendations, tourism (for example, a vacation recommendation), applications, learning/courses, bank services/products, or intrusion detection). While implementations in this disclosure are described based on examples where customers purchase items online, the described hybrid recommendation mechanism can also be applied to other customer interactions (such as, searching for items and viewing items online).

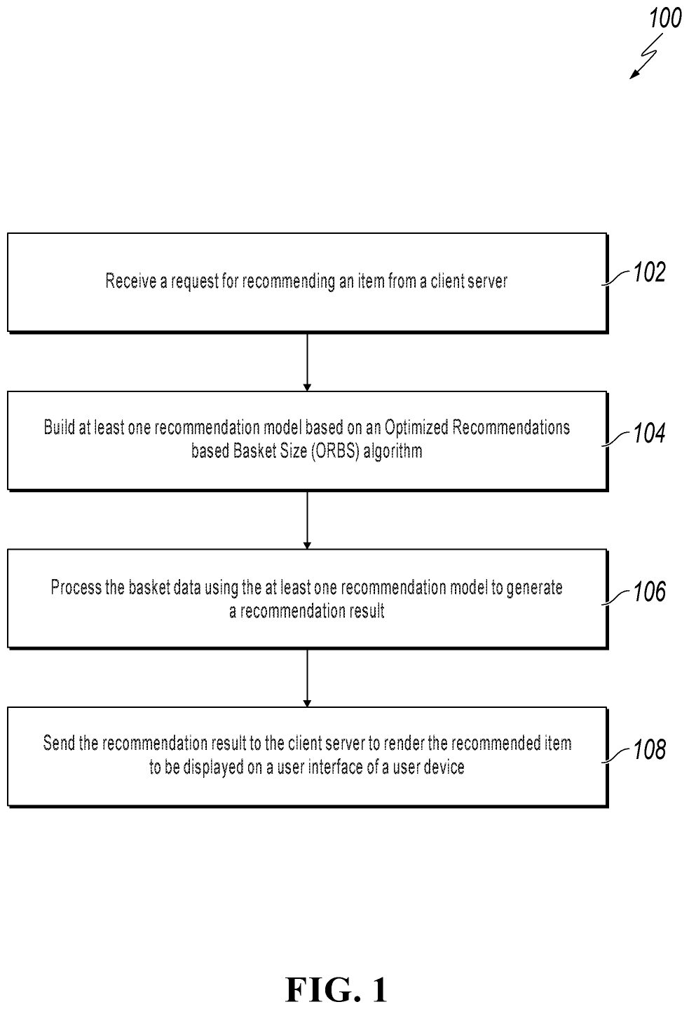

FIG. 1 is a flowchart illustrating an example of a computer-implemented method 100 for generating real-time recommendations based on a hybrid recommendation mechanism, according to an implementation of the present disclosure. For clarity of presentation, the description that follows generally describes method 100 in the context of the other figures in this description. However, it will be understood that method 100 can be performed, for example, by any system, environment, software, and hardware, or a combination of systems, environments, software, and hardware, as appropriate. In some implementations, various steps of method 100 can be run in parallel, in combination, in loops, or in any order.

At 102, a request for recommending an item is received from a client server. The request includes basket data, and the basket data is associated with multiple baskets and multiple items. In some implementations, once a consumer adds at least one item in an online shopping cart, the client server sends a request to the hybrid recommendation mechanism, requesting a recommendation for at least one more item for the consumer. The request includes data associated with the basket (that is, the transaction). For example, product metadata (data associated to item(s) that has been added to the basket or item(s)) and the size of the basket (that is, a number of the items in the basket) should be considered for recommendations.

In some implementations, besides transactional data, the request can also include other types of data (such as, user information, payment method, location, time, and consumer demographic data). In such cases, more than one algorithm can be used to build a recommendation model and the other types of data can be used to improve provided recommendation results.

At 104, at least one recommendation model is built based on an ORBS algorithm. The hybrid recommendation mechanism returns recommendations based on the received request. Different recommendation models are built according to the data received by the hybrid recommendation mechanism in the received requests.

In some implementations, where the received request only includes transactional data, the recommendation model can be generated based on the ORBS algorithm. In some implementations, where the request includes additional data that is not limited to the basket's data, more than one recommendation model can be built. One of the recommendation models can be generated based on the ORBS algorithm, and others can be based on different algorithms (such as, Contextual Top-N, ARs, CF, ORBS, or manual rules).

At 106, the basket data is processed using the recommendation model to generate a recommendation result that includes a recommended item. To process the basket data and generate a recommendation result, a score is determined for each candidate item (that is, items can be chosen by the hybrid recommendation mechanism to recommend to the consumer).

In some implementations, when the recommendation model is built only based on the ORBS algorithm, an ORBS score is determined for each candidate item based on equation (1). The item has the highest score is selected as the recommended item to the consumer.

In some implementations, when more than one recommendation model is generated, and other algorithms besides the ORBS algorithm are used, a series of scores are determined based on each of the other algorithms and subsequently aggregated to generate an aggregated score. In some implementations, this process can be performed in two steps. First, the generated different scores can be scaled (normalized) according to a common scale (0-1). For example, assume item X is an item already added to the cart, and Y is a plurality of items that can be recommended to the consumer. For each algorithm i, and each combination of items X∪Y, a scaled score for item Y when the recommendation model applies algorithm i can be determined by:

$$ScaledScore ( {S}_{i ( X ⋃ Y )} ) = \frac{{S}_{i ( X ⋃ Y )} - min ( {S}_{i} )}{max ( {S}_{i} ) - min ( {S}_{i} )} , \qquad ( 2 )$$

where: S_{i(X∪Y)} is a scaled score for an item Y when the recommendation model applies algorithm i, and min(Sᵢ) is a maximum score an item Y can receive when algorithm i is applied, and max(Sᵢ) is a minimum score an item Y can receive when algorithm i is applied.

Second, each algorithm is assigned a different weight w, and for each item Y, the scaled scores based on each algorithm are aggregated by:

AggregatedScore=Σᵢ(ScaledScore(S_{i(X∪Y)})×Wᵢ) (3),

where: w is a weight for algorithm i. The algorithm weighs w change frequently based on end user feedback; enabling the hybrid recommendation mechanism to learn and adopt a continuous optimal recommendation result.

At 108, the recommendation result is transmitted to the client server to render the recommendation result on a computer user interface of a user computing device.

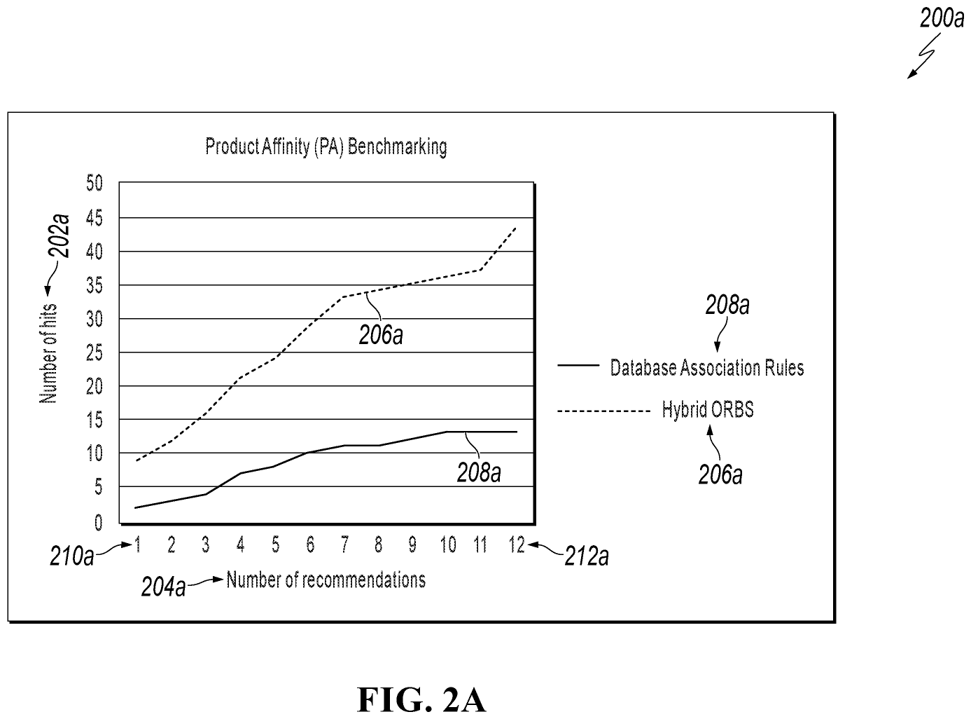

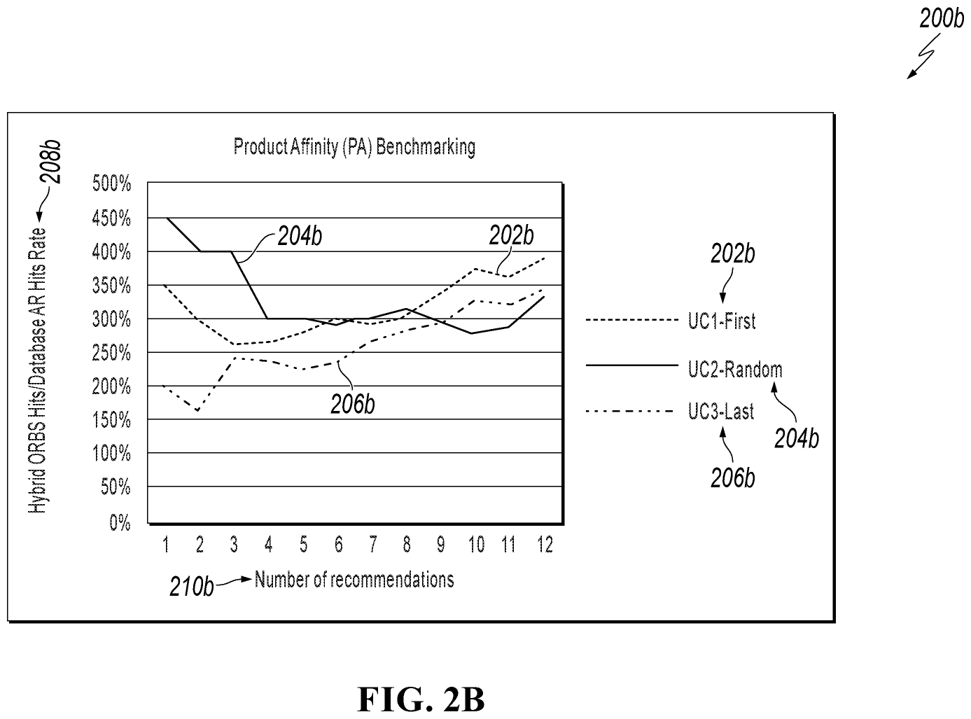

FIGS. 2A and 2B are graphs 200a and 200b, respectively, illustrating the result of a test performed to evaluate the hybrid recommendation mechanism (ORBS) performance, according to an implementation of the present disclosure. In this test, the benchmark performed to the hybrid ORBS mechanism on 9835 baskets, with 169 catalog items and a testing set of 100 baskets. 9735 baskets are used as training set to build the model and 100 baskets are used to test the model. FIG. 2A represents the number of hits out of 100 baskets. The result shown in FIG. 2A only refers to the test data. During the test, 100 baskets that were not part of the training data are taken. For each tested basket, one item is removed from the basket. If the system that applied the hybrid ORBS algorithm recommended the removed item within the top X items, a hit is considered generated. For example, if we take the top 5 recommendations for each basket, we have 8 hits out of 100 with the AR algorithm and 25 hits with the ORBS algorithm. This means that there are 25 baskets have been successfully guess for what the customer will add to the baskets (with showing each time 5 recommendations). Three different methods to remove the item are used and three testing use cases are conducted. In the first method, UC1, the first item is removed, in the second method, UC2, an item randomly selected from the basket is removed, and in the third method, UC3, the last item in the basket is removed. The difference of these three methods is the way the item is removed from the basket. For example, if the basket contains bread, milk and beer, for the first method, the bread is removed; for the second method, a random item was chosen and removed; and for the third method, the beer is removed. Then as check if the algorithm recommends a bear (in UC3) for the basket that contained milk and bread. The active algorithms in the experiment were: database ARs (for example, SAP HANA ARs), ORBS, Contextual Top-N (Popularity-based).

FIG. 2A is a graph 200a illustrating a comparison between a number of hits 202a generated and a number of recommendations 204a needed with respect to the hybrid recommendation mechanism 206a and database AR 208a hits on a second sample (UC2), according to an implementation of the present disclosure. As shown in FIG. 2A, for both approaches, as the number of recommendations 204a increases, the number of hits 202a increases accordingly. From the 1^{st} recommendation 210a to the 12^{th} recommendation 212a, each of the two mechanisms generated, the hybrid ORBS continually renders more hits than the database ARs.

FIG. 2B is a graph 200b illustrating, under three use cases (UC1, UC2, and UC3), 202b, 204b, and 206b, respectively, an improved hit rate of the hybrid recommendation mechanism in comparison to database ARs described in FIG. 2A, according to an implementation of the present disclosure. As shown in FIG. 2B, for each use case UC1 202b, UC2 204b, and UC3 206b, the ORBS algorithm can increase the Hybrid ORBS Hits/Database AR Hits Rate 208b by 160%-450%, in comparison to database ARs (for example, SAP HANA ARs), depending on the number of requested recommendations 210b. These figures show that the ORBS algorithm has a significant impact on the result.

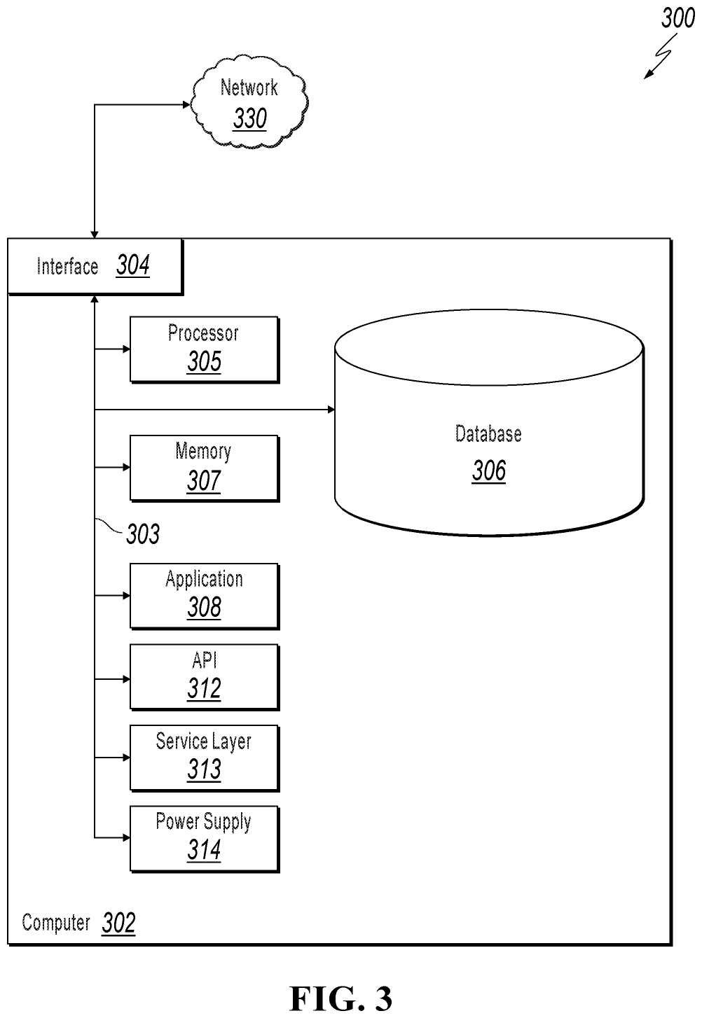

FIG. 3 is a block diagram illustrating an example of a computer-implemented System 300 used to provide computational functionalities associated with described algorithms, methods, functions, processes, flows, and procedures, according to an implementation of the present disclosure. In the illustrated implementation, System 300 includes a Computer 302 and a Network 330.

The illustrated Computer 302 is intended to encompass any computing device such as a server, desktop computer, laptop/notebook computer, wireless data port, smart phone, personal data assistant (PDA), tablet computer, one or more processors within these devices, another computing device, or a combination of computing devices, including physical or virtual instances of the computing device, or a combination of physical or virtual instances of the computing device. Additionally, the Computer 302 can include an input device, such as a keypad, keyboard, touch screen, another input device, or a combination of input devices that can accept user information, and an output device that conveys information associated with the operation of the Computer 302, including digital data, visual, audio, another type of information, or a combination of types of information, on a graphical-type user interface (UI) (or GUI) or other UI.

The Computer 302 can serve in a role in a distributed computing system as a client, network component, a server, a database or another persistency, another role, or a combination of roles for performing the subject matter described in the present disclosure. The illustrated Computer 302 is communicably coupled with a Network 330. In some implementations, one or more components of the Computer 302 can be configured to operate within an environment, including cloud-computing-based, local, global, another environment, or a combination of environments.

At a high level, the Computer 302 is an electronic computing device operable to receive, transmit, process, store, or manage data and information associated with the described subject matter. According to some implementations, the Computer 302 can also include or be communicably coupled with a server, including an application server, e-mail server, web server, caching server, streaming data server, another server, or a combination of servers.

The Computer 302 can receive requests over Network 330 (for example, from a client software application executing on another Computer 302) and respond to the received requests by processing the received requests using a software application or a combination of software applications. In addition, requests can also be sent to the Computer 302 from internal users (for example, from a command console or by another internal access method), external or third-parties, or other entities, individuals, systems, or computers.

Each of the components of the Computer 302 can communicate using a System Bus 303. In some implementations, any or all of the components of the Computer 302, including hardware, software, or a combination of hardware and software, can interface over the System Bus 303 using an application programming interface (API) 312, a Service Layer 313, or a combination of the API 312 and Service Layer 313. The API 312 can include specifications for routines, data structures, and object classes. The API 312 can be either computer-language independent or dependent and refer to a complete interface, a single function, or even a set of APIs. The Service Layer 313 provides software services to the Computer 302 or other components (whether illustrated or not) that are communicably coupled to the Computer 302. The functionality of the Computer 302 can be accessible for all service consumers using the Service Layer 313. Software services, such as those provided by the Service Layer 313, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the Computer 302, alternative implementations can illustrate the API 312 or the Service Layer 313 as stand-alone components in relation to other components of the Computer 302 or other components (whether illustrated or not) that are communicably coupled to the Computer 302. Moreover, any or all parts of the API 312 or the Service Layer 313 can be implemented as a child or a sub-module of another software module, enterprise application, or hardware module without departing from the scope of the present disclosure.

The Computer 302 includes an Interface 304. Although illustrated as a single Interface 304, two or more Interfaces 304 can be used according to particular needs, desires, or particular implementations of the Computer 302. The Interface 304 is used by the Computer 302 for communicating with another computing system (whether illustrated or not) that is communicatively linked to the Network 330 in a distributed environment. Generally, the Interface 304 is operable to communicate with the Network 330 and includes logic encoded in software, hardware, or a combination of software and hardware. More specifically, the Interface 304 can include software supporting one or more communication protocols associated with communications such that the Network 330 or hardware of Interface 304 is operable to communicate physical signals within and outside of the illustrated Computer 302.

The Computer 302 includes a Processor 305. Although illustrated as a single Processor 305, two or more Processors 305 can be used according to particular needs, desires, or particular implementations of the Computer 302. Generally, the Processor 305 executes instructions and manipulates data to perform the operations of the Computer 302 and any algorithms, methods, functions, processes, flows, and procedures as described in the present disclosure.

The Computer 302 also includes a Database 306 that can hold data for the Computer 302, another component communicatively linked to the Network 330 (whether illustrated or not), or a combination of the Computer 302 and another component. For example, Database 306 can be an in-memory, conventional, or another type of database storing data consistent with the present disclosure. In some implementations, Database 306 can be a combination of two or more different database types (for example, a hybrid in-memory and conventional database) according to particular needs, desires, or particular implementations of the Computer 302 and the described functionality. Although illustrated as a single Database 306, two or more databases of similar or differing types can be used according to particular needs, desires, or particular implementations of the Computer 302 and the described functionality. While Database 306 is illustrated as an integral component of the Computer 302, in alternative implementations, Database 306 can be external to the Computer 302. As illustrated, the Database 306 holds the previously described [data types].

The Computer 302 also includes a Memory 307 that can hold data for the Computer 302, another component or components communicatively linked to the Network 330 (whether illustrated or not), or a combination of the Computer 302 and another component. Memory 307 can store any data consistent with the present disclosure. In some implementations, Memory 307 can be a combination of two or more different types of memory (for example, a combination of semiconductor and magnetic storage) according to particular needs, desires, or particular implementations of the Computer 302 and the described functionality. Although illustrated as a single Memory 307, two or more Memories 307 or similar or differing types can be used according to particular needs, desires, or particular implementations of the Computer 302 and the described functionality. While Memory 307 is illustrated as an integral component of the Computer 302, in alternative implementations, Memory 307 can be external to the Computer 302.

The Application 308 is an algorithmic software engine providing functionality according to particular needs, desires, or particular implementations of the Computer 302, particularly with respect to functionality described in the present disclosure. For example, Application 308 can serve as one or more components, modules, or applications. Further, although illustrated as a single Application 308, the Application 308 can be implemented as multiple Applications 308 on the Computer 302. In addition, although illustrated as integral to the Computer 302, in alternative implementations, the Application 308 can be external to the Computer 302.

The Computer 302 can also include a Power Supply 314. The Power Supply 314 can include a rechargeable or non-rechargeable battery that can be configured to be either user- or non-user-replaceable. In some implementations, the Power Supply 314 can include power-conversion or management circuits (including recharging, standby, or another power management functionality). In some implementations, the Power Supply 314 can include a power plug to allow the Computer 302 to be plugged into a wall socket or another power source to, for example, power the Computer 302 or recharge a rechargeable battery.

There can be any number of Computers 302 associated with, or external to, a computer system containing Computer 302, each Computer 302 communicating over Network 330. Further, the term “client,” “user,” or other appropriate terminology can be used interchangeably, as appropriate, without departing from the scope of the present disclosure. Moreover, the present disclosure contemplates that many users can use one Computer 302, or that one user can use multiple computers 302.

Described implementations of the subject matter can include one or more features, alone or in combination.

For example, in a first implementation a computer-implemented method, comprising: receiving, from a client server, a request for recommending an item, wherein the request comprises baskets data, and wherein the basket data are associated with a plurality of baskets and a plurality of items; building, at least one recommendation model based on an Optimized Recommendations based Basket Size (ORBS) algorithm; processing the baskets data using the recommendation model to generate a recommendation result, wherein the recommendation result comprises a recommended item; and sending the recommendation result to the client server to render the recommended item to be displayed on a user interface of a user device.

The foregoing and other described implementations can each, optionally, include one or more of the following features:

A first feature, combinable with any of the following features, wherein processing the baskets data to generate a recommendation result comprises: determining, for each item, a ORBS score, and selecting an item having a highest ORBS score as the recommended item, wherein the ORBS score is determined based on:

$$ORBS = IFBS * IRF = \frac{CNTk ( X ⋃ Y )}{K} \times log \frac{N}{CNT ( Y )} ,$$

and wherein X is a current subject in a basket, Y is a candidate subject for the basket, CNTₖ (X∪Y)=number of times X and Y appear together in the same basket/transaction, out of baskets/transactions with maximum k items, K=number of baskets/transactions with maximum k items, N=total number of baskets/transactions, CNT(Y)=number of times Y appears in the total baskets/transactions, k is a predefined parameter, IFBS expresses how frequently the items X and Y appear together among baskets up to a certain size, and IRF expresses a rareness of a recommended item Y in the data set (a collection of all baskets/transactions).

A second feature, combinable with any of the previous or following features, wherein the request comprises additional data that are not baskets data, and wherein building at least one recommendation model comprise: building a first recommendation model based on the ORBS algorithm; and building a plurality of recommendation models, wherein each recommendation model is based on a different algorithm.

A third feature, combinable with any of the previous or following features, wherein processing the baskets data to generate a recommendation result comprises: determining, for each item, a plurality of scores based on different algorithms; aggregating, for each item, the plurality of scores to generate an aggregated score; and selecting an item having a highest aggregated score as the recommended item.

A fourth feature, combinable with any of the previous or following features, wherein aggregating the plurality of scores comprises: scaling each of the plurality of scores based on:

$$ScaledScore ( {S}_{i ( X ⋃ Y )} ) = \frac{{S}_{i ( X ⋃ Y )} - min ( {S}_{i} )}{max ( {S}_{i} ) - min ( {S}_{i} )} ;$$

And generating an aggregated scored based on:

AggregatedScore=Σᵢ(ScaledScore(S_{i(X∪Y)})×Wᵢ),

wherein i is a number of scores generated by different algorithms, min(Sᵢ) is the minimum score among determined scores, max(Sᵢ) is the maximum score among the determined scores, and Wᵢ is a weight of an algorithm.

A fifth feature, combinable with any of the previous or following features, further comprising receiving, user feedback from the client server.

A sixth feature, combinable with any of the previous or following features, further comprising updating a weight of each algorithm based on the user feedback.

In a second implementation, a non-transitory, computer-readable medium storing one or more instructions executable by a computer system to perform operations comprising: receiving, from a client server, a request for recommending an item, wherein the request comprises baskets data, and wherein the basket data are associated with a plurality of baskets and a plurality of items; building, at least one recommendation model based on an Optimized Recommendations based Basket Size (ORBS) algorithm; processing the baskets data using the recommendation model to generate a recommendation result, wherein the recommendation result comprises a recommended item; and sending the recommendation result to the client server to render the recommended item to be displayed on a user interface of a user device.

The foregoing and other described implementations can each, optionally, include one or more of the following features:

A first feature, combinable with any of the following features, wherein processing the baskets data to generate a recommendation result comprises: determining, for each item, a ORBS score, and selecting an item having a highest ORBS score as the recommended item, wherein the ORBS score is determined based on:

$$ORBS = IFBS * IRF = \frac{CNTk ( X ⋃ Y )}{K} \times log \frac{N}{CNT ( Y )} ,$$

and wherein X is a current subject in a basket, Y is a candidate subject for the basket, CNTₖ(X∪Y)=number of times X and Y appear together in the same basket/transaction, out of baskets/transactions with maximum k items, K=number of baskets/transactions with maximum k items, N=total number of baskets/transactions, CNT(Y)=number of times Y appears in the total baskets/transactions, k is a predefined parameter, IFBS expresses how frequently the items X and Y appear together among baskets up to a certain size, and IRF expresses a rareness of a recommended item Y in the data set (a collection of all baskets/transactions).

A second feature, combinable with any of the previous or following features, wherein the request comprises additional data that are not baskets data, and wherein building at least one recommendation model comprise: building a first recommendation model based on the ORBS algorithm; and building a plurality of recommendation models, wherein each recommendation model is based on a different algorithm.

A third feature, combinable with any of the previous or following features, wherein processing the baskets data to generate a recommendation result comprises: determining, for each item, a plurality of scores based on different algorithms; aggregating, for each item, the plurality of scores to generate an aggregated score; and selecting an item having a highest aggregated score as the recommended item.

A fourth feature, combinable with any of the previous or following features, wherein aggregating the plurality of scores comprises: scaling each of the plurality of scores based on:

$$ScaledScore ( {S}_{i ( X ⋃ Y )} ) = \frac{{S}_{i ( X ⋃ Y )} - min ( {S}_{i} )}{max ( {S}_{i} ) - min ( {S}_{i} )} ;$$

and generating an aggregated scored based on:

AggregatedScore=Σᵢ(ScaledScore(S_{i(X∪Y)})×Wᵢ),

wherein i is a number of scores generated by different algorithms, min(Sᵢ) is the minimum score among determined scores, max(Sᵢ) is the maximum score among the determined scores, and Wᵢ is a weight of an algorithm.

A fifth feature, combinable with any of the previous or following features, further comprising receiving user feedback from the client server.

A sixth feature, combinable with any of the previous or following features, further comprising updating a weight of each algorithm based on the user feedback.

In a third implementation, a computer-implemented system, comprising: one or more computers; and one or more computer memory devices interoperably coupled with the one or more computers and having tangible, non-transitory, machine-readable media storing one or more instructions that, when executed by the one or more computers, perform one or more operations comprising: receiving, from a client server, a request for recommending an item, wherein the request comprises baskets data, and wherein the basket data are associated with a plurality of baskets and a plurality of items; building, at least one recommendation model based on an Optimized Recommendations based Basket Size (ORBS) algorithm; processing the baskets data using the recommendation model to generate a recommendation result, wherein the recommendation result comprises a recommended item; and sending the recommendation result to the client server to render the recommended item to be displayed on a user interface of a user device.

The foregoing and other described implementations can each, optionally, include one or more of the following features:

A first feature, combinable with any of the following features, wherein processing the baskets data to generate a recommendation result comprises: determining, for each item, a ORBS score, and selecting an item having a highest ORBS score as the recommended item, wherein the ORBS score is determined based on:

$$ORBS = IFBS * IRF = \frac{CNTk ( X ⋃ Y )}{K} \times log \frac{N}{CNT ( Y )} ,$$

and wherein X is a current subject in a basket, Y is a candidate subject for the basket, CNTₖ(X∪Y)=number of times X and Y appear together in the same basket/transaction, out of baskets/transactions with maximum k items, K=number of baskets/transactions with maximum k items, N=total number of baskets/transactions, CNT(Y)=number of times Y appears in the total baskets/transactions, k is a predefined parameter, IFBS expresses how frequently the items X and Y appear together among baskets up to a certain size, and IRF expresses a rareness of a recommended item Y in the data set (a collection of all baskets/transactions).

A second feature, combinable with any of the previous or following features, wherein the request comprises additional data that are not baskets data, and wherein building at least one recommendation model comprise: building a first recommendation model based on the ORBS algorithm; and building a plurality of recommendation models, wherein each recommendation model is based on a different algorithm.

A third feature, combinable with any of the previous or following features, wherein processing the baskets data to generate a recommendation result comprises: determining, for each item, a plurality of scores based on different algorithms; aggregating, for each item, the plurality of scores to generate an aggregated score; and selecting an item having a highest aggregated score as the recommended item.

A fourth feature, combinable with any of the previous or following features, wherein aggregating the plurality of scores comprises: scaling each of the plurality of scores based on:

$$ScaledScore ( {S}_{i ( X ⋃ Y )} ) = \frac{{S}_{i ( X ⋃ Y )} - min ( {S}_{i} )}{max ( {S}_{i} ) - min ( {S}_{i} )} ;$$

and generating an aggregated scored based on:

AggregatedScore=Σᵢ(ScaledScore(S_{i(X∪Y)})×Wᵢ),

wherein i is a number of scores generated by different algorithms, min(Sᵢ) is the minimum score among determined scores, max(Sᵢ) is the maximum score among the determined scores, and Wᵢ is a weight of an algorithm.

A fifth feature, combinable with any of the previous or following features, further comprising receiving user feedback from the client server.

A sixth feature, combinable with any of the previous or following features, further comprising updating a weight of each algorithm based on the user feedback.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or an equivalent term as understood by one of ordinary skill in the art) refer to data processing hardware. Data processing hardware encompass all kinds of apparatuses, devices, and machines for processing data, including by way of example, a programmable processor, a computer, or multiple processors or computers. The computer can also be, or further include special purpose logic circuitry, for example, a central processing unit (CPU), a field programmable gate array (FPGA), or an application-specific integrated circuit (ASIC). In some implementations, the computer or computer-implemented system or special purpose logic circuitry (or a combination of the computer or computer-implemented system and special purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
receiving, from a client server, a request for recommending an item, wherein the request comprises baskets data, and wherein the basket data are associated with a plurality of baskets and a plurality of items;
building, at least one recommendation model based on an Optimized Recommendations based Basket Size (ORBS) algorithm;
processing the baskets data using the recommendation model to generate a recommendation result, wherein the recommendation result comprises a recommended item; and
sending the recommendation result to the client server to render the recommended item to be displayed on a user interface of a user device.

2. The computer-implemented method of claim 1, wherein processing the baskets data to generate a recommendation result comprises:
determining, for each item, a ORBS score, and
selecting an item having a highest ORBS score as the recommended item,
wherein the ORBS score is determined based on:
$$ORBS = IFBS * IRF = \frac{CNTk ( X ⋃ Y )}{K} \times log \frac{N}{CNT ( Y )} ,$$
and wherein X is a current subject in a basket, Y is a candidate subject for the basket, CNTₖ (X∪Y)=number of times X and Y appear together in the same basket/transaction, out of baskets/transactions with maximum k items, K=number of baskets/transactions with maximum k items, N=total number of baskets/transactions, CNT(Y)=number of times Y appears in the total baskets/transactions, k is a predefined parameter, IFBS expresses how frequently the items X and Y appear together among baskets up to a certain size, and IRF expresses a rareness of a recommended item Y in the data set.

3. The computer-implemented method of claim 1, wherein the request comprises additional data that are not baskets data, and wherein building at least one recommendation model comprise:
building a first recommendation model based on the ORBS algorithm; and
building a plurality of recommendation models, wherein each recommendation model is based on a different algorithm.

4. The computer-implemented method of claim 3, wherein processing the baskets data to generate a recommendation result comprises:
determining, for each item, a plurality of scores based on different algorithms;
aggregating, for each item, the plurality of scores to generate an aggregated score; and
selecting an item having a highest aggregated score as the recommended item.

5. The computer-implemented method of claim 4, wherein aggregating the plurality of scores comprises:
scaling each of the plurality of scores based on:
$$ScaledScore ( {S}_{i ( X ⋃ Y )} ) = \frac{{S}_{i ( X ⋃ Y )} - min ( {S}_{i} )}{max ( {S}_{i} ) - min ( {S}_{i} )} ;$$
and
generating an aggregated scored based on:
AggregatedScore=Σᵢ(ScaledScore(S_{i(X∪Y)})×Wᵢ),
wherein i is a number of scores generated by different algorithms, min(Sᵢ) is the minimum score among determined scores, max(Sᵢ) is the maximum score among the determined scores, and Wᵢ is a weight of an algorithm.

6. The computer-implemented method of claim 5, further comprising receiving user feedback from the client server.

7. The computer-implemented method of claim 6, further comprising updating a weight of each algorithm based on the user feedback.

8. A non-transitory, computer-readable medium storing one or more instructions executable by a computer system to perform operations comprising:
receiving, from a client server, a request for recommending an item, wherein the request comprises baskets data, and wherein the basket data are associated with a plurality of baskets and a plurality of items;
building, at least one recommendation model based on an Optimized Recommendations based Basket Size (ORBS) algorithm;
processing the baskets data using the recommendation model to generate a recommendation result, wherein the recommendation result comprises a recommended item; and
sending the recommendation result to the client server to render the recommended item to be displayed on a user interface of a user device.

9. The non-transitory, computer-readable medium of claim 8, wherein processing the baskets data to generate a recommendation result comprises:
determining, for each item, a ORBS score, and
selecting an item having a highest ORBS score as the recommended item,
wherein the ORBS score is determined based on:
$$ORBS = IFBS * IRF = \frac{CNTk ( X ⋃ Y )}{K} \times log \frac{N}{CNT ( Y )} ,$$
and wherein X is a current subject in a basket, Y is a candidate subject for the basket, CNTₖ (X∪Y)=number of times X and Y appear together in the same basket/transaction, out of baskets/transactions with maximum k items, K=number of baskets/transactions with maximum k items, N=total number of baskets/transactions, CNT(Y)=number of times Y appears in the total baskets/transactions, k is a predefined parameter, IFBS expresses how frequently the items X and Y appear together among baskets up to a certain size, and IRF expresses a rareness of a recommended item Y in the data set.

10. The non-transitory, computer-readable medium of claim 8, wherein the request comprises additional data that are not baskets data, and wherein building at least one recommendation model comprise:
building a first recommendation model based on the ORBS algorithm; and
building a plurality of recommendation models, wherein each recommendation model is based on a different algorithm.

11. The non-transitory, computer-readable medium of claim 10, wherein processing the baskets data to generate a recommendation result comprises:
determining, for each item, a plurality of scores based on different algorithms;
aggregating, for each item, the plurality of scores to generate an aggregated score; and
selecting an item having a highest aggregated score as the recommended item.

12. The non-transitory, computer-readable medium of claim 11, wherein aggregating the plurality of scores comprises:
scaling each of the plurality of scores based on:
$$ScaledScore ( {S}_{i ( X ⋃ Y )} ) = \frac{{S}_{i ( X ⋃ Y )} - min ( {S}_{i} )}{max ( {S}_{i} ) - min ( {S}_{i} )} ;$$
and
generating an aggregated scored based on:
AggregatedScore=Σᵢ(ScaledScore(S_{i(X∪Y)})×Wᵢ),
wherein i is a number of scores generated by different algorithms, min(Sᵢ) is the minimum score among determined scores, max(Sᵢ) is the maximum score among the determined scores, and Wᵢ is a weight of an algorithm.

13. The non-transitory, computer-readable medium of claim 12, further comprising receiving user feedback from the client server.

14. The non-transitory, computer-readable medium of claim 13, further comprising updating a weight of each algorithm based on the user feedback.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving, from a client server, a request for recommending an item, wherein the request comprises baskets data, and wherein the basket data are associated with a plurality of baskets and a plurality of items;
building, at least one recommendation model based on an Optimized Recommendations based Basket Size (ORBS) algorithm;
processing the baskets data using the recommendation model to generate a recommendation result, wherein the recommendation result comprises a recommended item; and
sending the recommendation result to the client server to render the recommended item to be displayed on a user interface of a user device.

16. The computer-implemented system of claim 15, wherein processing the baskets data to generate a recommendation result comprises:
determining, for each item, a ORBS score, and
selecting an item having a highest ORBS score as the recommended item,
wherein the ORBS score is determined based on:
$$ORBS = IFBS * IRF = \frac{CNTk ( X ⋃ Y )}{K} \times log \frac{N}{CNT ( Y )} ,$$
and wherein X is a current subject in a basket, Y is a candidate subject for the basket, CNTₖ (X∪Y)=number of times X and Y appear together in the same basket/transaction, out of baskets/transactions with maximum k items, K=number of baskets/transactions with maximum k items, N=total number of baskets/transactions, CNT(Y)=number of times Y appears in the total baskets/transactions, k is a predefined parameter, IFBS expresses how frequently the items X and Y appear together among baskets up to a certain size, and IRF expresses a rareness of a recommended item Y in the data set.

17. The computer-implemented system of claim 15, wherein the request comprises additional data that are not baskets data, and wherein building at least one recommendation model comprise:
building a first recommendation model based on the ORBS algorithm; and
building a plurality of recommendation models, wherein each recommendation model is based on a different algorithm.

18. The computer-implemented system of claim 17, wherein processing the baskets data to generate a recommendation result comprises:
determining, for each item, a plurality of scores based on different algorithms;
aggregating, for each item, the plurality of scores to generate an aggregated score; and
selecting an item having a highest aggregated score as the recommended item.

19. The computer-implemented system of claim 18, wherein aggregating the plurality of scores comprises:
scaling each of the plurality of scores based on:
$$ScaledScore ( {S}_{i ( X ⋃ Y )} ) = \frac{{S}_{i ( X ⋃ Y )} - min ( {S}_{i} )}{max ( {S}_{i} ) - min ( {S}_{i} )} ;$$
and
generating an aggregated scored based on:
AggregatedScore=Σᵢ(ScaledScore(S_{i(X∪Y)})×Wᵢ),
wherein i is a number of scores generated by different algorithms, min(Sᵢ) is the minimum score among determined scores, max(Sᵢ) is the maximum score among the determined scores, and Wᵢ is a weight of an algorithm.

20. The computer-implemented system of claim 19, further comprising receiving, user feedback from the client server.
